(19) United States
(12) Patent Application Publication
(10) Pub. No.: US 2021/0014948 A1
(43) Pub. Date: Jan. 14, 2021

(54) LED AND DISPLAY APPARATUS WITH VARIABLE INPUT VOLTAGE AND CONSTANT CURRENT DRIVE

(71) Applicant: Goodrich Corporation, Charlotte, NC (US)

(72) Inventor: Rajkumar Sengodan, Namakkal (IN)

(21) Appl. No.: 16/925,757

(22) Filed: Jul. 10, 2020

(30) Foreign Application Priority Data
Jul. 12, 2019 (IN) 201911028086

(51) Int. Cl. H05B 45/34; H05B 45/46; G09F 13/22

(52) U.S. Cl. CPC H05B 45/34; H05B 45/46; G09F 2013/227; G09F 2013/222; G09F 13/22

(57) ABSTRACT

Systems and methods for operating light emitting diodes (LEDs) circuits are provided. Aspects include a plurality of sets of light emitting diodes (LEDs), the plurality of sets of LEDs comprising a first set of LEDs and a second set of LEDs and a first current control circuit, wherein the first current control circuit is configured to determine whether a voltage through the first set of LEDs is below a first threshold and responsive to determining that the voltage through the first set of LEDs is below the first threshold, bypass the second set of LEDs.

### CROSS-REFERENCE TO RELATED APPLICATIONS

This application claims the benefit of Indian Patent Application No. 201911028086 filed Jul. 12, 2019, which is incorporated herein by reference in its entirety.

### BACKGROUND

The present invention generally relates to light emitting diodes (LEDs), and more specifically, to circuit and method for LEDs and display apparatus with variable input voltage and constant current drive.

A light-emitting diode (LED) circuit (also referred to as an LED driver) is an electrical circuit used to drive a string of LEDs. The LED driver circuit provides sufficient current to light the LED at the required brightness, while also limiting the current to prevent damaging the LED. Conventional LED driver circuits can suffer from under-voltage or fluctuating input voltage occurrences which can compromise the LED color temperature or can cause a turning-off of an LED string which can cause issues in power sensitive applications for LEDs such as LED drivers, displays and low power electronic devices in aircraft systems, automobiles, and consumer electronics.

### SUMMARY

Embodiments of the present invention are directed to system. A non-limiting example of the system includes a plurality of sets of light emitting diodes (LEDs), the plurality of sets of LEDs comprising a first set of LEDs and a second set of LEDs and a first current control circuit, wherein the first current control circuit is configured to determine whether a voltage through the first set of LEDs is below a first threshold and responsive to determining that the voltage through the first set of LEDs is below the first threshold, bypass the second set of LEDs.

Embodiments of the present invention are directed to a method for operating an LED circuit. A non-limiting example of the method includes providing a second current control circuit, wherein the second current control circuit is configured to determine whether a second voltage through the second set of LEDs is below a second threshold and responsive to determining that the voltage through the second set of LEDs is below the second threshold, bypass the third set of LEDs.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of a circuit topology driving a set of light emitting diodes according to one or more embodiments; and

FIG. 2 depicts a block diagram of a operating an LED circuit according to one or more embodiments.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, LEDs can be utilized in many power sensitive applications such as, for example, displays and low power electronic devices in aircraft lighting systems, aircraft interiors, aircraft display, landing lights, strobe lights for flashing emergency needs, automobiles, and commercial uses. However, as mentioned above, conventional LED driver circuits can suffer from under-voltage or fluctuating input voltage occurrences which can compromise the LED color temperature or can cause a turning-off of an LED string which can cause issues in power sensitive applications for LEDs such as LED drivers, displays and low power electronic devices in aircraft systems, automobiles, and consumer electronics.

The above-described aspects of the invention address the shortcomings of the prior art by providing an LED driving circuit that can overcome the under-voltage or fluctuating input voltage occurrences in convention LED driver circuits for driving constant current without compromising change in color temperature or turning-off the entire LED string and ensures minimum power loss in power sensitive applications for LED drivers. Embodiments herein include a LED driver circuit which yields LED drive more efficiently. The LED driver circuit can be configured in an energy efficient LED application where power conservation is needed. A segment control circuit is configured to selectively bypass at least one segment of an LED string responsive to a fluctuating input voltage by implementing metal-oxide semiconductor field effect transistors (MOSFETs) to operate in constant current mode for one or more LED segments. By this way, constant current for each LED segment is achieved during variable input voltage conditions. A variable/fluctuating input voltage will take place, for example, while a DC power source is unable to deliver required power due to circuit imbalance (i.e., multiple loads sinking the power greater than the available DC source capability) or while a power converter is operating in unstable region due to environmental/load factors/faulty feedback circuit. Another example include if the circuit is powered by 115 Vac single phase or 3 phase, variable input voltage occurs when the ac is converted to dc and the rectified voltage will vary depending on 115 Vac fluctuations from generator source/ram air turbine (RAT) for emergency power application.

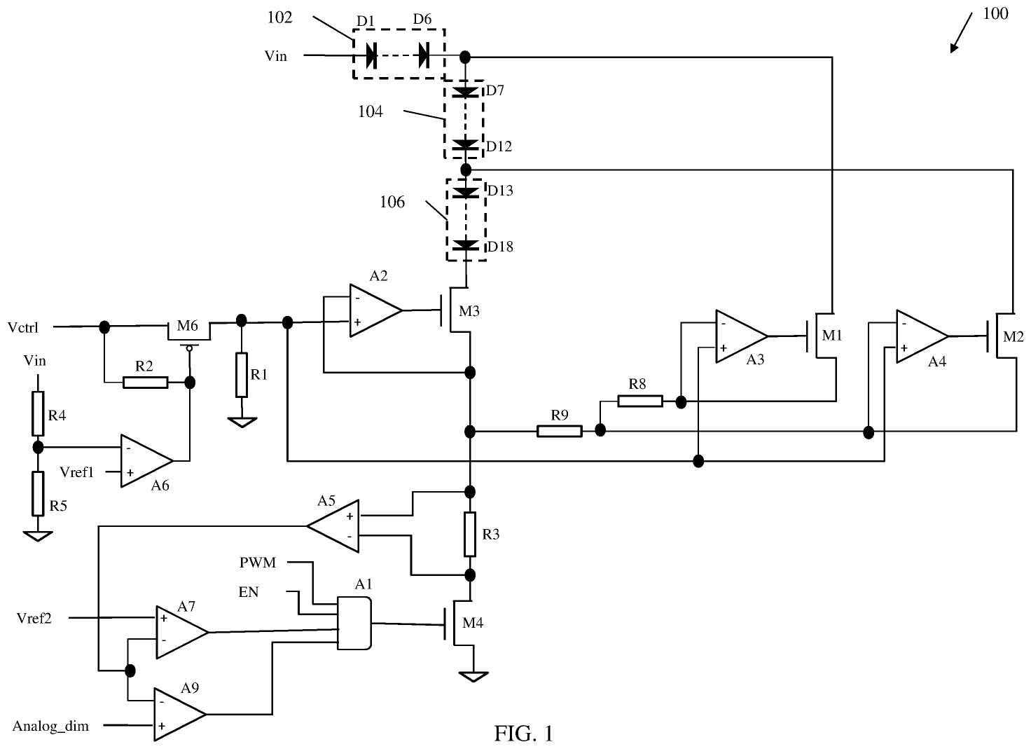

FIG. 1 depicts a block diagram of a circuit topology for an LED drive circuit with variable input voltage and constant current drive according to one or more embodiments. The LED input is provided with constant DC voltage. In order to maintain uniform brightness and color in a backlight, the LEDs are often driven using the same current regardless of variation of voltages at the input. For example, a single constant current source may be provided for an LED array to supply the same constant current to the LED array. In one or more embodiments, a single segment may include multiple LEDs connected in series, multiple LEDs connected in parallel, and/or multiple groups of parallel-connected LEDs coupled in series. FIG. 1 depicts the LED drive circuit 100 for LEDs connected in series (D1, D2, D3, . . . , D18). The LEDs are grouped into three LED segments 102, 104, and 106. LED segment 102 includes six LEDs labelled as D1 through D6. LED segment 104 includes six LEDs labelled as D7 through D12. And LED segment 106 includes six LEDs labelled as D13 through D18. An input voltage source Vin is coupled to the first LED segment 102. The LED segments 102, 104, 106 are in series with each other.

In one or more embodiments, a segment control unit includes an n-type MOSFET (nmos) which operates in a linear region for a constant current control. Each segment 102, 104, 106 can have multiple LEDs connected in series and is not limited to the number of LEDs in the illustrated example. In one or more embodiments, the number of LEDs in each segment can have the following expression to achieve higher light efficiency from a low input voltage: Segment1≤Segment2≤Segment3≤Segment N. In one or more embodiments, the LEDs in each segment are not limited to be in the above described configuration and can be configured based on worst case minimum Vin and the amount of required luminance for the LEDs.

In one or more embodiments, a first current control block includes LEDs (D1, D2, . . . , D6), MOSFET M1, along with a resistor R8 and operational amplifier (opamp) A3. The first current control block supplies power to the first LED segment 102. A second current control block includes LEDs (D1, D2, . . . D12), MOSFET M2, along with resistor R9, and opamp A4. The second current control block supplies power to the first LED segment 102 and the second LED segment 104. In one or more embodiments, a third current control block includes LEDs (D1, D2, . . . , D18), MOSFET M3, along with a resistor R3, and opamp A2. The third current control block provides power to the first LED segment 102, the second LED segment 104, and the third LED segment 106. In one or more embodiments, the MOSFETs M1, M2, M3 can operate in a linear region and MOSFET M4 can be configured to switch with low RDSon.

In one or more embodiments, the resistor R3 is the current sense resistor which generates proportional voltage to the current flow into it. The generated voltage is feedback to the current sense opamps A2, A3, A4 to achieve current control for each LED segment. During the first LED segment 102 operation, resistor R8, R9, and R3 are in series to perform current sense detection. Similarly for the first LED segment 102 and the second LED segment 104 operation, resistor R9 and R3 are in series to perform current sense detection. For first LED segment 102, second LED segment 104, and third LED segment 106 operation, resistor R3 will perform current sense detection.

In one or more embodiments, resistors R8, R9 are configured to be identical (0.01 ohms) in order to achieve equal voltage drops across R8 and R9 during variable input voltage. Vctrl is an analog input voltage applied to all segment drive control circuitry and it determines the threshold point to turn-off MOSFET M1, M2, M3, whereas resistor R3 determines the LED current.

In one or more embodiments, during operation of the LED driver circuit 100, consider the input voltage Vin being low (e.g., Vin=V1) and being able to turn on the first LED segment 102 only. In this scenario, MOSFET M1 starts to conduct with the provided Vctrl (e.g., 1V) to the non-inverting terminal of opamp A2 and the inverting terminal is assumed to at 0 V in an initial state. This condition will turn on the MOSFET M1 and current starts to flow through resistors R8, R9, R3 and MOSFET M4. The resistor R3 can be set at 3 ohms, R8 at 0.01 ohms, and R9 at 0.01 ohms with the net resistance being R8+R9+R3+Rdson. (M4 Rdson is considered to negligible). Therefore, the total resistance for current limit would be 3.02 ohms. The current linearly increases and at one point the inverting terminal and non-inverting terminal voltage will be equal which selects the MOSFET M1 operating point in the linear region. Even if the input voltage Vin increases then the excess voltage will get dropped across MOSFET M1 according to the following expression: V_{MOSFET M1}=Vin−V_{LED SEGMENT102}.

In one or more embodiments, consider the input voltage Vin increases from V1 to V2 (i.e., Vin=V2) and it is able to turn on the first LED segment 102 and the second LED segment 104. In this scenario, MOSFET M2 gradually starts conducting with the provided Vctrl and MOSFET M1 gradually stops conducting until the voltage across resistors R9 is lesser than the voltage across resistor R8. When VR9≥VR8, then MOSFET M1 completely stops conducting (i.e., the current stops flowing through R8). This condition will incline MOSFET M2 to operate in the linear region and current starts to flow through resistor R9, R3, and MOSFET M4. When resistor R3=3 ohms and resistor R9=0.01 ohms, the net resistance is R9+R3+M4_Rdson. Therefore, the total resistance for current limit would be 3.01 ohms. The voltage drop across MOSFET M2 is described in the following expression: V_{MOSFET M2}=Vin−V_{LED SEGMENT 102}−V_{LED SEGMENT 104}.

In one or more embodiments, the resistors R8 and R9 having identical, and low resistance values is due to the current through the LED strings are kept constant independent of different segments being on or off during operation.

In one or more embodiments, consider the input voltage Vin increases from V2 to V3 and it able to turn on the first LED segment 102, the second LED segment 104, and the third LED segment 106. In this scenario, MOSFET M3 gradually starts conducting with the provided Vctrl and MOSFET M2 gradually stops conducting until the voltage across resistor R3 is less than R9. When V_{R3}≥V_{R9}, then MOSFET M2 completely stops conducting (i.e., the current stops flowing through R9). This condition will incline MOSFET M3 to operate in the linear region and current starts to flow through resistor R3 and MOSFET M4. Therefore, the net resistance for current limit would be 3 ohms, considering negligible M4 Rdson. The voltage drop across MOSFET M3 is described in the following expression: V_{MOSFET M3}=Vin−V_{LED SEGMENT 102}−V_{LED SEGMENT 104}−V_{LED SEGMENT 106}.

In one or more embodiments, each LED segment is regulated with constant current regardless of connecting or disconnecting the number of segments. Considering if the voltage starts to be reduced from V3 to V2 and V1, then the same principle is applicable as described above.

In one or more embodiments, an LED turn on threshold circuit adds the advantage of limiting the LED turn on with minimum forward bias conditions. In this condition, the LED does not provide required drive current to achieve desired color temperature and luminance which can affect the performance of the lighting system. During successive turn on transition period of the second LED segment 104 and the third LED segment 106, the effect would be considerably lesser than the initial turn on period because the first LED segment 102 is already illuminating with consistent luminance and the difference in color temperature would be less. The p-type MOSFET (PMOS) M6 is configured as a switch with low Rdson and controlled by comparator A6. Resistors R4 and R5 act as a potential divider network for the comparator inverting input. Vref1 provides a reference voltage which keeps PMOS M6 in an OFF state until Vin rises above a set threshold. When Vin increases above Vref1, then PMOS M6 will turn ON, which bypass Vin voltage for current control MOSFET M1, M2, and M3. Pulse width modulation (PWM) dimming is provided with MOSFET M4 configured with AND gate A1. AND gate A1 receives input from Enable (En), current limit comparator A7, and analog dimming comparator A9. The current limit provision will limit the circuit from overdriving the LEDs and Analog dimming provision will provide potentiometer/analog voltage based LED current control. In one or more embodiments, A5 is a difference amplifier which can sense the voltage across R3. The A7 comparator non-inverting terminal will receive input voltage Vref2 (fed externally) and the inverting terminal receives input from the A5 output. The A7 comparator will compare the over current threshold limit across R3 with respect to Vref2. If the voltage across R3 is higher than Vref2 then A7 output will be logic LOW. This will disable the A1 AND gate output to logic LOW and disable M4 to OFF. In one or more embodiments, the A9 comparator non-inverting terminal will receive an input voltage “Analog dimming” (fed externally) and the inverting terminal receives input from the A5 output. The A9 comparator will compare the current across R3 with respect to the Analog dimming. If voltage across R3 is higher than the Analog dimming voltage then the A9 output will be logic LOW. This will disable the A1 AND gate output to logic LOW and disable M4 to OFF. Analog dimming is a brightness control feature similar to PWM.

In one or more embodiments, any of the hardware referenced in the system 100 can be implemented by executable instructions and/or circuitry such as a processing circuit and memory. The processing circuit can be embodied in any type of central processing unit (CPU), including a microprocessor, a digital signal processor (DSP), a microcontroller, an application specific integrated circuit (ASIC), a field programmable gate array (FPGA), or the like. Also, in embodiments, the memory may include random access memory (RAM), read only memory (ROM), or other electronic, optical, magnetic, or any other computer readable medium onto which is stored data and algorithms as executable instructions in a non-transitory form.

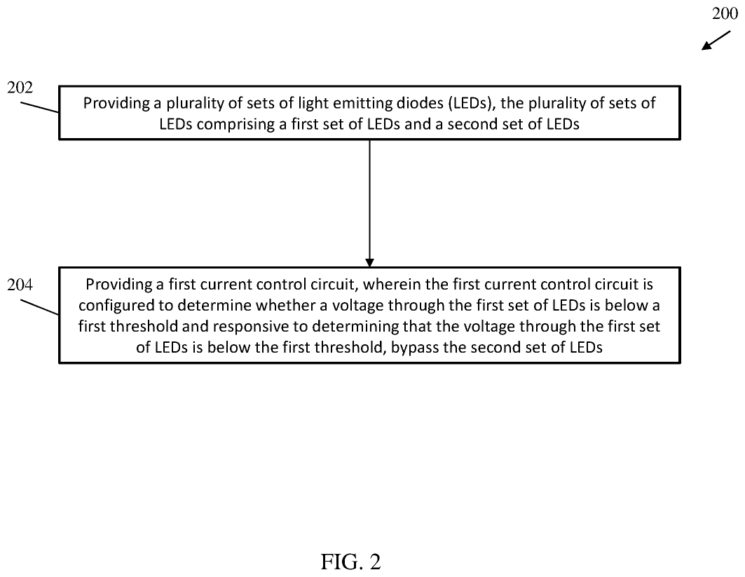

FIG. 2 depicts a block diagram of a method for operating an LED circuit according to one or more embodiments. The method 200 includes providing a plurality of sets of light emitting diodes (LEDs), the plurality of sets of LEDs comprising a first set of LEDs and a second set of LEDs, as shown in block 202. And at block 204, the method 200 includes providing a first current control circuit, wherein the first current control circuit is configured to determine whether a voltage through the first set of LEDs is below a first threshold and responsive to determining that the voltage through the first set of LEDs is below the first threshold, bypass the second set of LEDs.

Additional processes may also be included. It should be understood that the processes depicted in FIG. 2 represent illustrations, and that other processes may be added or existing processes may be removed, modified, or rearranged without departing from the scope and spirit of the present disclosure.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A system comprising:
a plurality of sets of light emitting diodes (LEDs), the plurality of sets of LEDs comprising a first set of LEDs and a second set of LEDs; and
a first current control circuit, wherein the first current control circuit is configured to:
determine whether a voltage through the first set of LEDs is below a first threshold; and
responsive to determining that the voltage through the first set of LEDs is below the first threshold, bypass the second set of LEDs.

2. The system of claim 1, wherein the first current control circuit is further configured to shut off responsive to determining that the voltage through the first set of LEDs is above the first threshold.

3. The system of claim 2, wherein the first current control circuit comprises:
a switch;
a resistor; and
an operational amplifier.

4. The system of claim 3, wherein the switch comprises a metal-oxide semiconductor field effect transistor.

5. The system of claim 3, wherein the switch is controlled by an output of the operational amplifier.

6. The system of claim 5, wherein determining whether the voltage through the first set of LEDs is below the first threshold comprises:
receiving, at a non-inverting input of the operational amplifier, the first threshold voltage;
receiving, at an inverting input of the operation amplifier, a resistor voltage across the resistor;
controlling the switch based on a comparison of the first threshold voltage to the resistor voltage.

7. The system of claim 1, wherein the plurality of sets of LEDs further comprises a third set of LEDs; and further comprising:
a second current control circuit, wherein the second current control circuit is configured to
determine whether a second voltage through the second set of LEDs is below a second threshold; and
responsive to determining that the voltage through the second set of LEDs is below the second threshold, bypass the third set of LEDs.

8. The system of claim 7, wherein the second current control circuit is further configured to shut off responsive to determining that the second voltage through the second set of LEDs is above the second threshold.

9. The system of claim 1, wherein the plurality of sets of LEDs are connected in series.

10. The system of claim 1, wherein the plurality of sets of LEDs are connected in parallel.

11. A method for operating a light emitting diode (LED) driver circuit, the method comprising:
providing a plurality of sets of light emitting diodes (LEDs), the plurality of sets of LEDs comprising a first set of LEDs and a second set of LEDs; and
providing a first current control circuit, wherein the first current control circuit is configured to:
determine whether a voltage through the first set of LEDs is below a first threshold; and
responsive to determining that the voltage through the first set of LEDs is below the first threshold, bypass the second set of LEDs.

12. The method of claim 11, wherein the first current control circuit is further configured to shut off responsive to determining that the voltage through the first set of LEDs is above the first threshold.

13. The method of claim 12, wherein the first current control circuit comprises:
a switch;
a resistor; and
an operational amplifier.

14. The method of claim 13, wherein the switch comprises a metal-oxide semiconductor field effect transistor.

15. The method of claim 13, wherein the switch is controlled by an output of the operational amplifier.

16. The method of claim 15, wherein determining whether the voltage through the first set of LEDs is below the first threshold comprises:
receiving, at a non-inverting input of the operational amplifier, the first threshold voltage;
receiving, at an inverting input of the operation amplifier, a resistor voltage across the resistor;
controlling the switch based on a comparison of the first threshold voltage to the resistor voltage.

17. The method of claim 11, wherein the plurality of sets of LEDs further comprises a third set of LEDs; and further comprising:
providing a second current control circuit, wherein the second current control circuit is configured to:
determine whether a second voltage through the second set of LEDs is below a second threshold; and
responsive to determining that the voltage through the second set of LEDs is below the second threshold, bypass the third set of LEDs.

18. The method of claim 17, wherein the second current control circuit is further configured to shut off responsive to determining that the second voltage through the second set of LEDs is above the second threshold.

19. The method of claim 11, wherein the plurality of sets of LEDs are connected in series.

20. The method of claim 11, wherein the plurality of sets of LEDs are connected in parallel.
